(19) United States
(12) Patent Application Publication
(10) Pub. No.: US 2017/0232303 A1
(43) Pub. Date: Aug. 17, 2017

(54) SWIMMER HAND PADDLE

(71) Applicant: TRC Innovation, Inc., Ormand Beach, FL (US)

(72) Inventors: Tony V Chadwick, Ormand Beach, FL (US); Rodney V Chadwick, Durango, CO (US)

(21) Appl. No.: 15/296,130

(22) Filed: Oct. 18, 2016

Related U.S. Application Data
(60) Provisional application No. 62/294,838, filed on Feb. 12, 2016.

(51) Int. Cl. A63B 31/10; G09B 19/00

(52) U.S. Cl. CPC A63B 31/10; G09B 19/0038

(57) ABSTRACT

The present disclosure relates to improved hand swimmer paddles with a bifurcation along a hinged joint that may be placed over a metacarpophalangeal joint of a swimmer. In addition, methods of manufacturing the improved hand swimmer hand paddles with bifurcated portion and methods of training with the improved swimmer hand paddles are also disclosed.

### CROSS REFERENCE TO RELATED APPLICATIONS

This non-provisional patent application claims priority to Provisional Patent Application 62/294,838 filed Feb. 12, 2016 and entitled Improved Swimmer Paddle, the contents of which are incorporated herein by reference in their entirety.

### FIELD OF THE DISCLOSURE

The present disclosure relates to improved hand swimmer paddles, methods of manufacturing the improved hand swimmer hand paddles and methods of training with the improved swimmer hand paddles.

### BACKGROUND OF THE DISCLOSURE

Swimming is not an innate activity for human beings. For the most part it is a learned skill, especially when the intricate mechanics of competitive swimming strokes are considered. During competitive swimming strokes, the laws of physics and fluid dynamics come together to create the mechanics used to propelling a human body through the water at a maximum speed. As such, many aspects involved in the competitive swimming strokes complement each other to facilitate efficient stroke mechanics. Efficient stroke mechanics enable a swimmer to achieve a maximum distance travelled as a result of the stroke.

In many competitive athletic endeavors various training methods and training tools are constantly being developed and improved to enhance performance. There have been many training tools for swimmers to use in the water to develop strength to improve technique. Swim paddles are one of many such tools. Originally developed to produce resistance during the stroke by increasing the displacement of the hand area, paddles were designed to increase strength in the major muscle groups related to the swim stroke. However, flat paddles may do more harm than good by overtraining some aspects of a swimmers physiology and imparting poor stroke mechanics.

Benjamin Franklin invented an early version of swimmer hand paddles, which were essentially flat paddles that were strapped to the hand and used to provide increased propulsion. During the intervening years from Benjamin franklin's time to the present, very little has changed in the way of swimmer hand paddles. Essentially, swimmer hand paddles consisted or a single flat paddle and came in one size for all swimmers.

Swim paddles have evolved over the years from two rectangular panels into various shapes and sizes but they are solid static paddles. Use of solid static paddles may result in swimmers developing shoulder problems ranging from rotator cuff tears to strains. Shoulder problems result from the paddles having a bigger displacement which amplifies deleterious affects of the improper stroke execution.

### SUMMARY OF THE INVENTION

Accordingly, the present disclosure provide unique bifurcated swim paddles and method steps may be performed during the use of the bifurcated swim paddles. Although the methods are generally discussed in relation the breaststroke, the methods presented are generally applicable to all four competitive strokes, including: freestyle, breaststroke, backstroke and butterfly. The methods combine motions involved in human competitive swim strokes with physics of particular shapes and sizes of bifurcated swim paddles and fluid dynamics as the swim paddles pass through water during one or more of the competitive swim paddles.

In some aspects, the present invention provides devices and methods for improving the mechanics of the human body during execution of competitive swim strokes. In particular, it develops aspects of competitive swimming strokes during the five basic phases of a stroke pattern. The physics and fluid dynamic effects of using the bifurcated swim paddles are similar for all four strokes.

Bifurcated paddles according to the present invention include designs and methods of use to enhance proper entry position of the hand as it enters the water. The bifurcation and hinge features encourage proper stroke technique by amplifying negativity of an errant stroke execution and thereby discovery of poor stroke mechanics. For example, swimmer wearing bifurcated paddles who employs a short stroke entry wherein the arm is not extended far enough out in front of the shoulder, and/or placing a hand at the wrong angle relative to the bottom of the pool, and/or fingertips pointing downward, experiences a plowing impact during the extension phase of the stroke execution. The plowing creates greater drag resistance on the upper area of the hand and paddle as it is pushed through the water.

Consequently, a swimmer wearing a bifurcated swimmer paddle according to the present invention and who utilizes a poor stroke technique will experience a force on their hand and arm in a downward direction to the bottom of an associated pool and out of the proper stroke configuration. The downward pulling force allows the summer to be alerted to the problem immediately and to correct it in real time. By comparison a swimmer training without a paddle can be committing an error in his or her stroke without it ever being obvious that the poor stroke mechanics are affecting their speed through the water.

In addition to the bifurcation of the paddle into at least two paddle portions, the improved swimmer paddles according to the present design include additional features that provide superior functionality. Features include a hinge panel placed at the MCP joint which produces important physiological benefits by allowing the hand to flex naturally throughout the stroke pattern at the MCP joint. Flexing the paddle at the MCP joint engages a swimmer's hand and forearm area such that the small synergistic muscles receive exercise as well engage the connective tissues such as ligaments and tendons in the fingers. The flex action of the hands in the swim stroke is slight but the small amount of movement allowed by the hinge and the panel is sufficient to keep the connective tissue pliable and healthy.

In addition to the flex action, the bifurcated swim paddles provide for a recovery phase of the stroke when the hand and wrist are at their most relaxed the small synergistic muscles and ligaments of the swimmer may recover more completely than if the hand remained in a static position. This aspect is a tremendous physiological benefit over the thousands of strokes involved in a 1000 to 1500 m workout.

The hinge also allows for a better “feel” for the water by allowing a natural hand motion throughout the entire stroke especially during entry, catch and pull phases of a swim stroke. The improved swimmer paddle provides a feel for the water that is accentuated by a general shape of the paddle which resembles the actual outline of the hand of the swimmer.

Another aspect of the paddle that contributes to the feel for the water includes channels in a surface of the portion of the panel that engages the water below the fingers. The channels discourage sideslip and enable the paddle to be pulled and pushed through the water with fluid dynamics encouraging proper stroke form. In some embodiments holes through the paddle can also facilitate minimal sideslip during the stroke aspects. In preferred embodiments, a general shape of the paddle intentionally matches the general outline of a swimmers hand and consequently tapers from the hinge area to the fingertips to provide optimal fluid dynamics performance and yet also increase the surface area of the hand and thereby increase the resistance to motion experienced by the hand, arm and shoulder as the swim stroke is executed.

Some paddles may be designed to maximize a strength building effect of a paddle workout at the same time emphasizing and configuring and enforcing proper stroke mechanics. Both these outcomes are accomplished by the incorporation of a unique hinge design.

Poor stroke mechanics during an extension phase of a stroke may do more to slow down a swimmer and decrease his or her distance per stroke than any other flaw in any other portion of the stroke. Improper entry extension while wearing the bifurcated paddles will be immediately evident to the swimmer as the smooth flow and path of the swimmers is disrupted. An improper stroke with the paddles will cause resistance to the swimmer who feels as if they are “fighting” the paddle. A proper stroke will feel natural and provide real time feedback to the swimmer that their stroke mechanics are proper. In this fashion, the real time feedback allows a swimmer to correct stroke mechanics during a workout and not have to wait for feedback from an observer, wherein the observer may only provide feedback following swimming with improper stroke mechanics. The real time stroke mechanics feedback is provided via downward pressure exerted on the hand holding the paddle as the swimmer swims. Correction to the stroke mechanics will immediately alleviate the downward pressure and provide additional mid-stroke feedback that proper swim mechanics are being executed.

As swimmer stroke mechanics are corrected and the stroke is performed properly the paddles will pull through the water smoothly. Even though the paddles pull through smoothly when the stroke is performed correctly, there is still ample resistance being created by the improved swimmer paddles to produce a very effective strength building workout. The stroke mechanics diagnostics of the panels are equally effective in the breaststroke and the backstroke as they are in the freestyle stroke. Strength building aspects and the stroke mechanics aspects of the swim paddles compliment each other to produce technically correct stronger and ultimately faster swimmers.

With regard to strength building aspect the unique and design of the hand is able to move through the complete range of motion throughout the entire stroke pattern. This allows for exercise of the small synergistic muscles in the hand and lower arm as well as allowing movement of the tendons and ligaments which helps keep the connective tissue pliable and healthy. As a result of a more comprehensive workout of the upper body portion of the swim stroke is achieved.

Enabling a swimmer to maintain proper stroke technique throughout an entire workout via mid-stroke feedback induces muscle memory of the stroke mechanics which the swimmer retains even when the swimmer is competing without the paddles attached to their hands. A muscle memory resulting from swimming hundreds of strokes during a workout incorporates proper stroke technique and muscle relaxation response during a swimming race that is less likely to break down as a result of swimmer fatigue during competition.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates a perspective view of some exemplary implementations of the present invention.

FIG. 2 illustrates a front view of improved swimmer's paddles according to some embodiments of the present invention.

FIG. 3 illustrates a top down view of improved swimmer's paddles according to some embodiments of the present invention.

FIG. 4 illustrates a side view of improved swimmer's paddles according to some embodiments of the present invention.

FIG. 5 illustrates a top down view of improved swimmer's paddles with hand and finger placement, according to some embodiments of the present invention.

FIG. 6 illustrates a side view of improved swimmer's paddles with a first portion and a second portion flexed at an angle to each other.

FIG. 7 illustrates a top down view of improved swimmer's paddles with hand and finger placement while a first portion and a second portion are flexed at an angle to each other.

FIG. 8 illustrates flow chart of methods that may be practiced according to some embodiments of the present invention.

FIG. 9 illustrates a side view of improved swimmer's paddles and the influence of a bend in the paddle on a swimmer stroke.

### DETAILED DESCRIPTION

The present disclosure provides generally for improved swimmer hand paddles, and in particular swimmer hand paddles with at least one hinge portion allowing for increased performance and additional training characteristics as compared to previous models of swimmer hand paddles. According to the present disclosure, a first portion of the swimmer paddle engages a wrist of a swimmer and secures the first paddle portion to the wrist of the swimmer. A second paddle portion is fixedly attached to the first portion via a hinge portion. A swimmer may flex their hand to change an angle of the first paddle in relation to the second paddle portion. In addition, a, a swimmer may change rotational movement of a lower arm attached to a paddle and thereby change a rotational angle with which the paddle moves through the water.

Bifurcated swim paddles can be used in training with all four strokes: freestyle semicolon backstroke semicolon breaststroke to the water for stroke. The present invention with bifurcated swim paddles and unique methods provide for the development and enhancement of a) proper stroke mechanics semicolon and b) development of strength in the major and minor muscle groups involved in a practice stroke.

Unlike previously known paddles, use of the bifurcated paddle and method steps exercises synergetic muscles involved in an engaged swim stroke while also promoting connect the tissue ligament and tendon health in the hand and wrist area.

According to some embodiments of the present invention, bifurcated swim paddles may contain several features that complement each other to accomplish training objectives. The features in bifurcated paddles include its unique hinge design placing a hinge in the panel at the metacarpophalangeal joints (MCP) refer to the joints between the metacarpal bones and the phalanges of the fingers. In the present disclosure, the MCP joint includes a knuckle area between the hand and the finger, including an MC joint and CP joint where the fingers join the palm portion of the hand allows the hand to flex and the paddle with it this flex action produces many benefits which are described as follows.

In the following sections, detailed descriptions of examples and methods of the disclosure will be given. The description of both preferred and alternative examples though through are exemplary only, and it is understood that to those skilled in the art that variations, modifications, and alterations may be apparent. It is therefore to be understood that the examples do not limit the broadness of the aspects of the underlying disclosure as defined by the claims.

Bifurcated Swimmer Paddle as used herein refers to an apparatus with a first portion that may be removably attached to a wrist and across a volar (palm) of a human swimmer while a second portion is attached to the fingers (phalanges) along the metacarpophalangeal joints.

The surface area of a Bifurcated Swimmer Paddle preferably increases the surface area of with which a hand of a swimmer engages water in which the swimmer is swimming. However, in other embodiments, the surface area of the Bifurcated Swimmer Paddle may be approximately the same as the surface area of the swimmers hand, or even less than the surface area of a hand.

According to some embodiments of the present invention, an improved swim training tool is provided with features that complement each other. The tool includes a unique hinged design to promote physiologically sound strength development and stroke mechanic enhancement. A long standing principal of athletic training states “the best way to train for an athletic activity is the activity itself”. The present invention enables an athlete to build strength for swimming while the swimmer's stroke is influenced to perform each stroke in a physiologically effective manner. The swimmer's muscles are used in the stroke and developed through a full range of motion as they are used to perform the stroke in a manner induced by wearing a hinged paddle with water flow grooves. Strokes that may be used for training, include, without limitation, breaststroke, backstroke and freestyle.

Various aspects of the disclosed paddles perform one or more specific functions and to complement each other to produce a physiologically superior training tool. The design of the disclosed paddles is based upon extensive study of stroke mechanics and hydrokinetic forces and hours of testing by swimmers in a pool.

According to the present invention, a size and shape of portions of the paddle work together to produce an optimum amount of resistance for physiologically sound strength development and accurate distribution of hydrokinetic forces on the surface area of the paddle. In some embodiments, a bottom or palm portion of the paddle closely follows a shape of the palm and is designed for unencumbered flex action at the wrist. The present invention recognizes in order to build strength that there is no need for an extremely large surface area of a front portion of the paddle. The larger portion may create excessive resistance and inhibit training. The present invention is based upon training in a pull workout and is based upon a principal of low resistance strokes and high repetition training. The principal of low resistance strokes and high repetition is also utilized to develop neurological pathways. The shape of the paddle is designed to mimic the shape of the hand. The present invention exerts hydrokinetic forces on the surface of the paddle in a manner replicating those exerted on the hand when swimming without paddles. The grooves on the underside of the finger portion of the paddle are aligned with the fingers and mimic the indentations between the fingers of the bare hand. The grooves serve a dual purpose, they assist in the distribution of hydrokinetic forces on the surface of the paddle and they help to eliminate side slip action during the power phase of the stroke. The accurate distribution of hydrokinetic forces upon the surface area of the paddle allows the swimmer to naturally and comfortably keep the swimmer's hand properly positioned for efficient stroke mechanics and to internally rotate the arm at the shoulder joint to achieve a high elbow position at the catch and maintain it through the stroke.

The hinge, located at the Metacarpal-phalangeal joint (the “MCP join”) where the fingers meet the palm of the hand. Allowing the paddle to conform to the hand and flex naturally through the entire stroke pattern from entry, to catch, through the power phase, exit, and recovery, creates physiological and functional advantages over a static paddle. For one, the paddle is simply much more comfortable with which to swim during a long pull workout. While the actual flex action of the hand throughout the stroke pattern is slight, it does occur. By allowing the hand to flex slightly as opposed to pushing against a static paddle that won't move, fatigue and stress upon the connective tissue and small synergistic muscles in the hand and forearm is greatly reduced. This will help keep the tendons and ligaments in the hand pliable and healthy and allow for physiological development of the smaller synergistic muscles in the hand and forearm. This reduction in fatigue in the hand and forearm transfers all the way through the arm and to the large muscle groups which produce the power in the stroke. This may sound small and insignificant, but tenths and hundredths of a second are also small but not insignificant at the end of a race.

The flex action of the paddle coupled with the attributes previously discussed regarding size, shape, and hydrokinetic forces promotes good hand position and feel for the water throughout the entire stroke pattern. The ability to identify flaws in stroke mechanics is a tremendous asset for swimmers training with disclosed paddles. One example of this is alerting the swimmer to a flawed entry, particularly in freestyle and backstroke. For example, a short entry in the freestyle stroke with the fingers pointing even slightly down produces a plowing effect slowing down the swimmers progress through the water and contributes to poor hand position to initiate the catch. The hinge allows for the majority of the displacement surface area of the paddle to be above the MCP joint. As a result, the disclosed paddles are very sensitive to the position of the hand on the entry, if the hand enters at a poor angle, the added displacement of the upper portion of the paddle amplifies the force being applied to the back of the hand during the plowing motion and causes the paddle to flex pulling the hand out of the stroke pattern. The paddle performs similarly in backstroke and breaststroke promoting good hydrodynamic hand position in all three strokes. This allows the swimmer to correct the flaws in real time on the next stroke and causes the swimmer to swim with good stroke mechanics throughout the entire workout. This in turn may be used to develop very strong neurological pathways or what is commonly called muscle memory. This muscle memory helps the swimmer to maintain good stroke mechanics all throughout a race, whether it's a sprint or 1500 meters, especially towards the end of the race when the swimmer's stroke has a tendency to break down due to fatigue.

In another aspect, the present invention provides a paddle that enables a swimmer to grasp the gutter or the edge of the pool between sets if the lane in which they are training which is typically six feet deep.

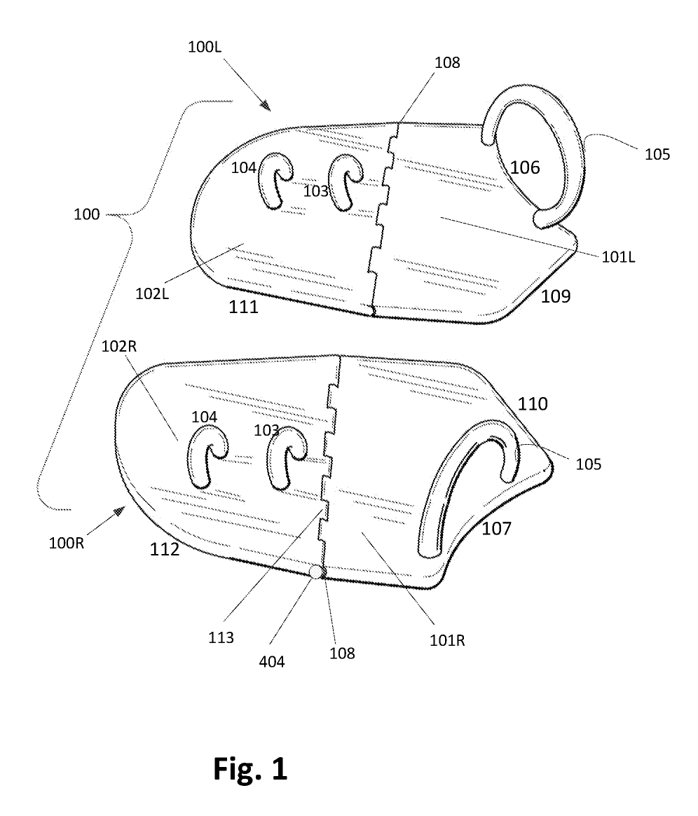

Referring now to FIG. 1, a perspective view of swimmer hand paddles 100L-100R according to some implementations of the present invention are illustrated. Each swimmer hand paddle 100L-R includes a respective hinge portion 108 connecting a first portion 101L-R of the swimmer paddle 100 with a second portion 102L-R of the swimmer paddle 100. The first portion may be secured to a wrist and volar region of a swimmer via a wrist strap 105. The first paddle portion includes a generally planar top surface and a generally arcuate front edge with a back edge shaped to interface with hinge 108 to a respective second paddle portion 102L-R. The first paddle portion additionally includes a generally planer lower surface. The generally planar lower surface may, in some embodiments include one or more channels for channeling water as the first portion is moved through water.

Respective second paddle portions 102L-R are fixedly attached to the respective front portions 101L-R via a hinge 108 creating a paddle bifurcated via the hinge. A hinge 108 may include a typical door style hinge including a barrel and pin used to cause paddle freedom of movement. The barrel hinge may include a sectional barrel that essentially includes a multiple hollow cylinder shaped sections 113 secured by a pin 404. Other hinge designs may also be utilized, such as, for example, a flexible or semi flexible area that may be formed in a rigid or semi rigid material, such as, for example via a score line.

The first portion 101L-R of the swimmer paddle 100 may be secured to the wrist and/or volar region of a swimmer, for example via and a wrist strap 105. Similarly, the second portion 102L-R may be secured to one or more fingers of the swimmer via respective finger straps 103-104. In some embodiments, one or more finger straps 103-104 may secure a single finger to a first paddle portion 10L-R or one or more finger straps 103-104 may secure two or more fingers to a first paddle portion 101L-R. A swimmer may flex their hand to change an angle of the first paddle portion 101 in relation to the second paddle portion 102. In some preferred embodiments, the wrist strap 105 and the finger straps 103-104 may include an elastic strap, such as a strap comprising surgical tubing. Other embodiments may include a hook and loop type strap or a buckle allowing for adjustment in strap length.

According to the present invention, swimmer hand paddles 100L-R may have distinct shapes conducive to a right hand 100R or a left hand 100L of a swimmer. The distinct shapes may include a wrist receiving area 106-107 for receiving a wrist of the swimmer and allowing for ease of movement of the swimmers wrist during a swim stroke via a concave arcuate receiving surface 106-107. The arcuate receiving area may be adjacent to a generally planar portion 109-110 on an upper side in relation to the wrist receiving area 107-108 and an arcuate or curved portion 111-112 on a lower side in relation to the wrist receiving portion 107-108.

First paddle portions 101L-R and second paddle portions 102 L-R may move freely with a hand movement and with minimal restriction. This allows the bifurcated paddle 100L-R to be sensitive and react to proper hand position on the entry phase of the swim stroke. Minimal additional force is required other than an amount of force applied by placement of the hand in the water and the extension of the arm to a catch position to activate the panel.

During a swim stroke, if a hand position is incorrect or if there is a flaw in any one of the five phases of the swim stroke, an entire stroke may suffer. However, it has been found that a flaw in the entry phase of a swim stroke can do more to slow a swimmer's progress through the water than other stroke deficiencies. Accordingly, as discussed herein, the present invention addresses flaws in a swimmer's stroke as the swimmer executes the entry phase of a stroke. The paddles according to the present invention provide feedback with no artificial delay built in, such as waiting for a swim stroke to finish, or a swimming lap to finish before feedback is provided. Feedback is provided via the presence or absence of upward and/or downward pressure during an improper stroke execution, and may also include sideways pressure during improper stroke execution.

In another aspect, the present invention involves all of the agonistic, antagonistic, and synergistic throughout the entire stroke pattern, and to allow more for movement of the connective tissue, the tendons, and ligaments in the hand and wrist area.

The swimmer paddles may be formed from a water impervious rigid or semi rigid material, such as a plastic. Plastics may include, by way of non-limiting example, one or more of: thermoplastics, thermosets, polyethylene, polyolefin, polystyrene, Polyvinyl chloride, polypropylene, high density polyethylene, low density polyethylene (LDPE) polyurethane, Polyvinylidene chloride (PVDC) or other homopolymer of vinylidene chloride, epoxy or equivalent. The paddles may be machined, or molded, such as, for example via thermal based injection molding processes. In some embodiments, a bifurcated swimmer paddle according the present invention may be formed via additive manufacturing, such as 3D printing. Additive manufacturing may be include a size and shape of a swimmer paddle based upon one or more of: a measurement of one or more aspects of a swimmer's hand (such as width and length of each side of a hand in relation to a MCP joint), a scan of a swimmer's hand and an objective of training with the swimmer paddles.

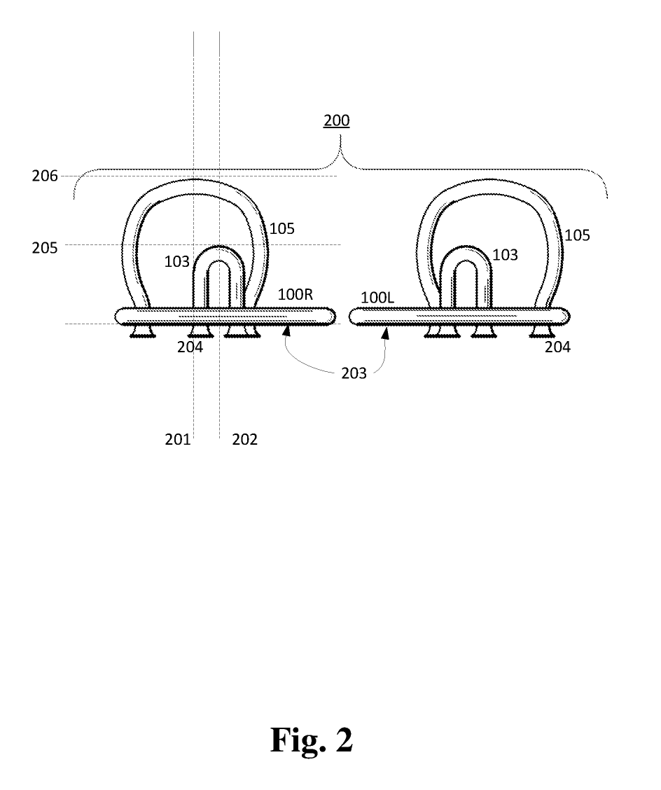

Referring now to FIG. 2, a front view of swimmer's paddles 200 is illustrated with attachment straps 103, 105, including wrist straps 105 and one or more finger straps 103 fixedly attached to each paddle 203. The wrist straps 103-105 may be elastic to allow for ease in securing and removing the paddles 203 to a swimmer's hand. Other means of securing the paddles 203 to a swimmers hand are also within the scope of the invention. For example, a hook and loop (i.e. Velcro™) secured strap or a strap with a snap, button or other fastener are within the scope of the present invention. A fixing feature 204 secures the strap to the paddle 203. The fixing feature 204 may include a friction fitting with a small hole through which a tubular elastic strap is threaded or one or more of: a rivet, a screw, a knot, glue or other mechanism for securing the strap 103-105 to the paddle 203.

According to some embodiments of the present invention, a center line 202 of one or more finger straps 103 is offset as compared to a center line 201 of an associated wrist strap 105. The offset may be positioned to secure a selected finger, such as the middle finger to the paddle 203 and allow for proper positioning of the paddle over the hand and fingers.

Similarly, an elastic wrist strap 105 for securing a hand to the paddle may have a large height 206 than a height 205 of an elastic finger strap 103.

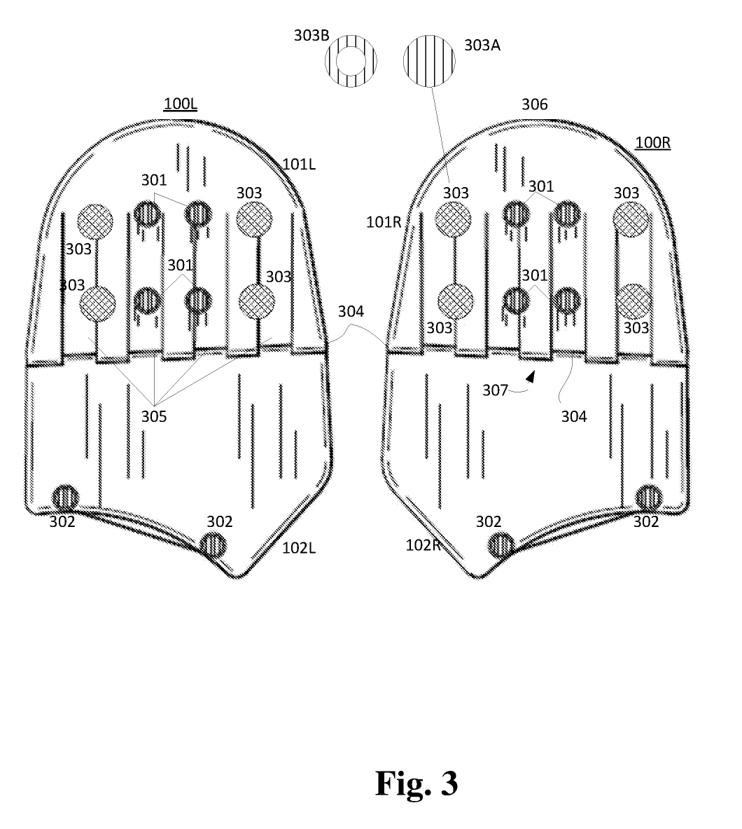

Referring now to FIG. 3 an underside view illustrating the lower side of bifurcated swimmer paddles 100L-R includes vias, through connections or access holes 301-302 that may be used to secure attachment straps (not shown in this figure) to the paddles 101L-101R. In addition, water flow portals 303 may be formed to allow water to flow through the paddle and thereby decrease the resistance of the paddle passing through the water. The water flow portals 303 may also provide fluid flow that provides a fluid force to guide the bifurcated paddle 101L-101R as it travels through the water and help prevent side motion of the paddles 100L-100R. In some embodiments, a plug or covering 302A may restrict and thereby reduce water flow through the water flow portals 303 or eliminate water flow through the water flow portals 303. Covering all or a portion of the water flow portals 303 allows for a swimmer to adjust an amount of resistance a swimmer paddle 100L-R during a swimming workout. In some implementations, a portion of the access holes 302 may be partially restricted by covering them with an annular shaped cover that creates a smaller radius opening than the entire access hole 302. Other shapes are also within the scope of the present invention.

Some implementations of the present invention include one or more water channels 305 visible in a bottom view of the swimmer paddles 100L-R. The water channels guide a flow of water under the swimmer paddle 100L-R as the paddle passes through the water. The guided flow of water stabilizes the path of the swimmer paddle 100L-R and reduces a tendency to move sideways. In some exemplary implementation, a channel may be between about 30 mils and 250 mils deep and between about 0.25 inches wide and 1.0 inches wide.

In another aspect, the water channels 305 may be in a direction essentially congruent with a direction of the fingers of a swimmer to which the swimmer paddle 100L-R is attached. In some embodiments, the channels 305 may run along an entire span of the second portion 102L-R. In other embodiments, the channels 305 may run along only part of the second portion 102L-R.

The underside view of FIG. 3 provides a view of a barrel type hinge 304 that may be used to flexibly attach a first portion 101L-R and a second portion 102L-R. Other means to flexibly attach a first portion 101L-R and a second portion 102L-R are within the scope of the present invention, such as an area of decreased modulus, such as a score line, or line of thinner material.

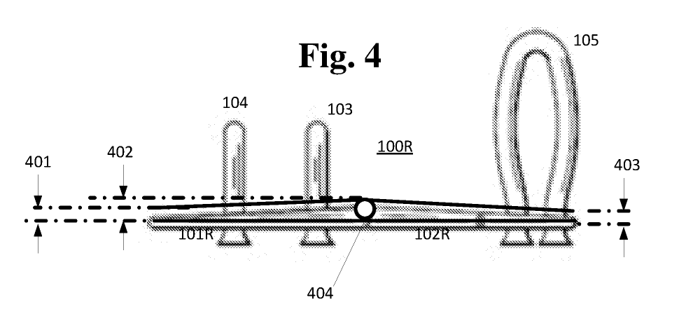

Referring now to FIG. 4 a profile view of a right hand swimmer paddle 100R is illustrated with attachment straps 103-105. A pin 404 of a barrel hinge is viewable. The barrel hinge may include a sectional barrel that essentially includes a multiple hollow cylinder shaped sections secured by a pin 404. In some implementations of the present invention, a thickness of a first portion 101R and a second portion 102R may include a thicker profile at a hinged portion 402 than at a front taper 401 or a rear taper 403.

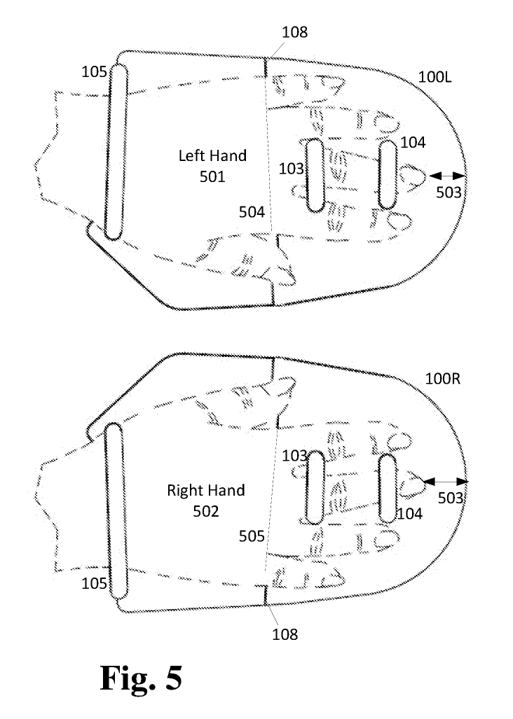

Referring now to FIG. 5 an overhead view illustrates a left hand swimmer paddle 100L and a right hand swimmer paddle 100R with an outline of respective human hand 501-502. The hands 501-502 are fixedly secured to the swimmer paddles 100L-100R via finger straps 103-104 and a wrist strap 105. The bifurcated swim paddles 100L-R include a design with a hinge 108 that is placed at metacarpophalangeal joints (MCP joint) refer to the joints 504-505 between the metacarpal bones and the phalanges. In the present disclosure, the MCP joint includes a knuckle area between the hand and the finger, including an MC joint and CP joint where the fingers join the palm portion of the hand and the straps 103-105 allow the hand to flex and also flex the paddle along the hinge 108.

The surface area of a bifurcated Swimmer Paddle 100L-R preferably increases the surface area of with which a hand of a swimmer engages water in which the swimmer is swimming. The increase in paddle size as compared to the hand 503 in preferably about 10% more than the surface area of the hand itself. However, in other embodiments, the surface area of the Bifurcated Swimmer Paddle may be more than about 10% larger or approximately the same as the surface area of the swimmers hand, or even less than the surface area of a hand.

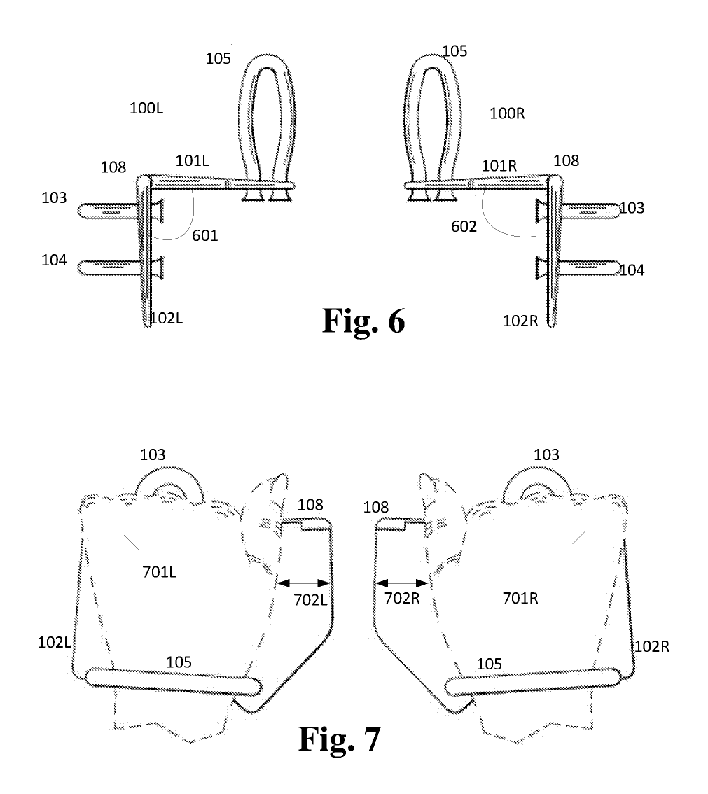

FIG. 6 illustrates a profile view of improved swimmer's paddles 100L-R with respective front portions 101L-R and second portions 102L-R flexed at an angle 601-602 to each other. In preferred embodiments, the angle 601-602 is between about 0 degrees and 90 degrees. During a preferred swim stroke, flex of the respective front portions 101L-R and second portions 102L-R will generally be between about zero degrees and thirty degrees.

FIG. 7 illustrates a top down view of second portions 102L-R improved swimmer's paddles with a respective left hand 701L and right hand 701R secured to the respective left second portion 102L and right second portion 102R. The hands 701L-R may be secured with a strap 103, 105. FIG. 7 additionally illustrates the increase in surface area 702L-R provided by the second portion 102L-R of a swimmer paddle in relation to a respective hand 701 L-R. As illustrated, the first paddle portions (not viewable in this drawing) and the respective second paddle portion 120L-R are angled at the hinge portion 108 into a non-planar position. This is sometimes referred to as a flexed position.

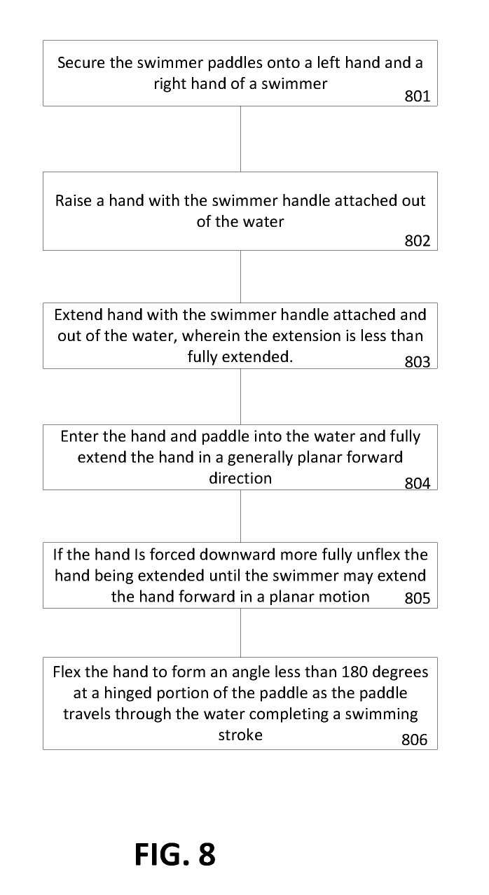

FIG. 8 illustrates flow chart of methods that may be practiced according to some embodiments of the present invention. At step 801, the may be secured onto a hand and a right hand of a swimmer. At step 802 the swimmer may raise a hand with the swimmer handle attached to it, out of the water. At step 803, the swimmer may extend the hand with the swimmer handle attached to it. In some embodiments, the extension may be less than a full extension of the swimmer's arm. Also, in some embodiments, the extension may be partially or completely conducted while the swimmers arm is out of the water.

At step 804, the swimmer may enter the hand and paddle into the water and move the hand through at least a portion of a swim stroke, the portion of a swim stroke may include, for example, fully extending the hand in a generally planar forward direction. At step 805, if the hand receives downward pressure during the stroke and is forced downward as the arm extends forward, the paddle is providing in stroke feedback on swim stroke execution. In some embodiments, improper stroke execution may also include upward or sideways pressure. To correct stroke mechanics based upon the in stroke feedback, the swimmer may more fully unflex the hand (or remove some of the flex provided to the swimmer paddle along the joint) being extended as the swimmer extends the hand forward in a planar motion. Alternatively, according to the present invention the swimmer may increase an amount of downward pressure by providing an additional amount of flex to the swimmer paddle along the joint. A sideways pressure may be corrected by changing a side to side angle at which the swimmer brings their hand, and the attached paddle through the water.

At step 806, the swimmer may flex the hand and paddle to an angle less than 180 degrees at the hinged portion of the paddle as the paddle travels through the water and complete the swim stroke. The swimmer may also adjust the angle of the flex and thereby adjust the depth of the stroke as explained further below. Immediate feedback is provided via the pressure exerted on the paddle and the swimmers hand as the swimmer moves the paddle through the water. The swimmer may also adjust a rotational angel with which the swimmers wrist and the attached paddle moves through the water and receive mid-stroke feedback via side to side pressure of the paddle as it moves through the water. Proper rotational angle will result in minimal side to side pressure.

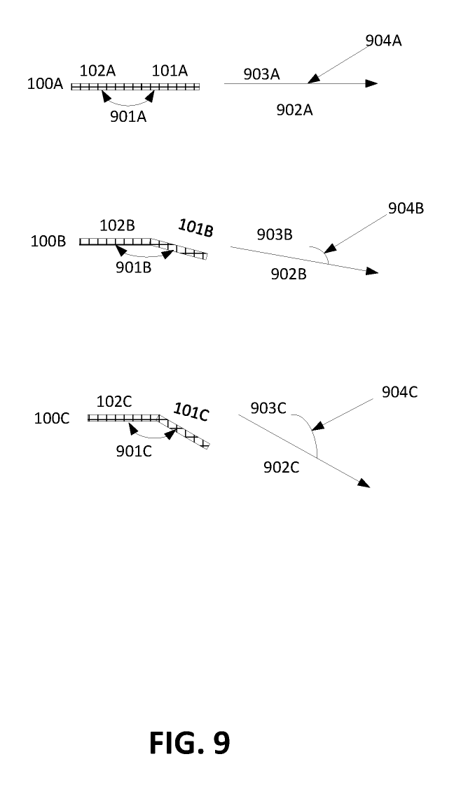

Referring now to FIG. 9, a change in an angle of a flex of a swim paddle according to the present invention may affect an angle of extension forward of a swim stroke. A swimmer paddle 100A includes a first portion 101A and a second portion 102A in a planer configuration, as demonstrated by an angle 901A of 180° (or0°) in relation to the first portion 101A and the second portion 102A. Based upon the 180° angle, an extension path 902A that is essentially linear in a forward direction with no downward movement based upon the angle 901A of the first paddle portion 101A and the second paddle portion 102A.

A swimmer paddle 100B includes a first portion 101B and a second portion 102B with an angle 901B slightly less than 180° in relation to the first portion 101B and the second portion 102B. Based upon the angle 901B slightly less than 180° in relation to the first portion 101B and the second portion 102B, an extension path 902B will include an angle 904B slightly downward due to pressure exerted by fluid dynamics on the swimmer paddle 100B as the swimmer paddle 100B is moved in a forward direction through the water during the extension part of a swimming stroke.

A swimmer paddle 100C includes a first portion 101C and a second portion 102C with an angle 901C more less than 180° than illustrated in 100B in relation to the first portion 101C and the second portion 102C. Based upon the angle 901C slightly less than 180° in relation to the first portion 101C and the second portion 102C, an extension path 902C will include an angle 904C more significantly downward due to pressure exerted by fluid dynamics on the swimmer paddle 100C as the swimmer paddle 100C is moved in a forward direction through the water during the extension part of a swimming stroke.

It may be noted that the present invention provides for additional training in that if the arm motion of the swimmer training with the swimmer paddle is not properly extended and the hand is not properly cupped, the hand will be forced downward when it enters the water. The present invention encourages proper form and through the entirety of the swim stroke.

In another aspect, the present swimmer paddle of the present invention may be sized according to one or more of: the size of the swimmer; the strength of the swimmer and the health condition of the swimmer's arm and/or shoulder.

In still another respect the swimmer paddles of the present invention may include channels in one or both portions of the paddle or to guide the path of swimmer paddles through the water. The channels may be positioned in a position to cause a direction of motion in a keel like manner.

The swimmer paddles of the present invention may be injection molded or 3D printed or machined according to specific circumstances of the users. By way of non-limiting example, in some embodiments, a size a hand of a swimmer may be measured and referenced in generating a size of the Swimmer Paddles. The swimmer paddles may then be readily translated into a design file for generation of an additive printer or 3D printing apparatus. In addition, a sequence of paddle sizes may be used during a workout, such as, for example, beginning with a smaller paddle and progressing up to a larger paddle during a workout, or vice versa.

### Conclusion

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1) A method of training a swimmer with an improved swimmer paddle, the method comprising the steps of:
securing a first portion of a bifurcated swimmer paddle to a wrist and across a palm of a hand of the swimmer;
securing a second portion of the bifurcated swimmer paddle across fingers of the swimmer, wherein the second portion is attached to the first portion at a joint via a hinge;
arranging the hinge across a metacarpophalangeal joint of the swimmer;
placing the hand and paddle under water;
flexing the swimmer paddle along the joint via the hinge;
moving the hand and paddle through at least a portion of a swim stroke; and
providing mid-stroke feedback to the swimmer via pressure exerted on the paddle as the swimmer moves the paddle through the water.

2) The method of claim 1 additionally comprising the step of changing the mid-stroke feedback via changing an amount of flexing of the swimmer paddle along the joint via the hinge as the paddle moves through the water.

3) The method of claim 2 wherein the bifurcated swimmer paddle is secured to the wrist via a strap.

4) The method of claim 3 wherein the strap comprises an elastic material.

5) The method of claim 2 wherein the bifurcated swimmer paddle is secured to a finger with a strap.

6) The method of claim 4 wherein the bifurcated swimmer paddle is secured to a finger with multiple straps.

7) The method of claim 1 additionally comprising the step of guiding a flow of water under the swimmer paddle via multiple water channels formed into one or both of the first portion of the swimmer paddle and the second portion of the swimmer paddle, as the paddle passes through the water; and
stabilizing a side to side travel of the swimmer paddle as a result of passing the water through the channels.

8) The method of claim 7 wherein the water channels are in a direction essentially congruent with a direction of the fingers attached to the swimmer paddle.

9) The method of claim 7 wherein the water channels are between about 30 mils and 250 mils deep.

10) The method of claim 9 wherein the water channels are between about 0.25 and 1.0 inches wide.

11) The method of claim 1 wherein the swim paddle is flexed along the joint via a barrel type hinge with multiple hollow cylinder sections secured with a pin.

12) The method of claim 1 wherein the swim paddle is flexed along the joint comprising scored plastic.

13) The method of claim 1 wherein the wrist of the swimmer is secured to the swimmer paddle at a concave arcuate receiving area allowing for ease of movement of the swimmers wrist during a swim stroke.

14) The method of claim 1 wherein the portion of a swim stroke comprises fully extending the hand in a generally planar forward direction while the hand and paddle are under water.

15) The method of claim 14 wherein an amount of downward force on the swimmer paddle and hand is based upon an amount of flexing of the swimmer paddle along the joint.

16) The method of claim 15 additionally comprising the step of increasing the amount of downward force by providing an additional amount of flex to the swimmer paddle along the joint.

17) The method of claim 15 additionally comprising the step of decreasing the amount of downward force by removing some of the flex to the swimmer paddle along the joint.

18) The method of claim 1 additionally comprising the step of passing water through multiple water portals formed into one or both of the first portion of the swimmer paddle and the second portion of the swimmer paddle, as the paddle passes through the water; and stabilizing a side to side travel of the swimmer paddle as a result of passing the water through the water portals.

19) The method of claim 18 additionally comprising the step of adjusting a size of the water portals with an annular shaped covering.

20) An improved swimmer paddle comprising:
a first paddle portion with a first generally planar top surface and a generally arcuate front edge with a back edge shaped to interface with hinge portion, said first paddle portion additionally comprising a generally planar lower surface, said generally planar lower surface additionally comprising one or more channels for channeling water as the first portion is moved through water;
said hinge portion fixedly attached to the first portion and a second paddle portion; and
said second paddle portion comprising a front edge shaped to interface with hinge portion and a back edge generally shaped to interface with a human wrist, said second paddle portion additionally comprising a generally planer lower surface, said lower surface additionally comprising one or more channels for channeling water as the second portion is moved through the water.
